(19) United States
(12) Patent Application Publication
(10) Pub. No.: US 2012/0114134 A1
(43) Pub. Date: May 10, 2012

(54) METHODS AND APPARATUS FOR CONTROL AND TRAFFIC SIGNALING IN WIRELESS MICROPHONE TRANSMISSION SYSTEMS

(75) Inventors: Junyi Li, Chester, NJ (US); Mathew Scott Corson, Gillette, NJ (US); Thomas J. Richardson, South Orange, NJ (US); Frank A. Lane, Easton, PA (US)

(73) Assignee: QUALCOMM Incorporated, San Diego, CA (US)

(21) Appl. No.: 13/217,187

(22) Filed: Aug. 24, 2011

Related U.S. Application Data
(60) Provisional application No. 61/376,803, filed on Aug. 25, 2010.

(51) Int. Cl. H04B 3/00

(52) U.S. Cl. 381/77

(57) ABSTRACT

Methods and apparatus for controlling the communications between a wireless microphone receiver and one or more wireless microphone transmitters are described. In accordance with some embodiments a common control channel is used for communicating control signals between the wireless microphone receiver and one or more wireless microphone transmitters, while separate audio data channels are used to carry audio data traffic from each individual wireless microphone transmitter to the microphone receiver. In accordance with some other embodiment, a time division approach is used in which there are microphone transmit time periods and control signaling time periods. During the microphone transmit time periods, wireless microphone transmitters transmit audio data signals and, in some embodiment, control signals, to the wireless microphone receiver using separate frequency subbands within a frequency band. During control signaling time periods, the wireless microphone receiver transmits a control signal to a wireless microphone transmitter using the frequency band.

### RELATED APPLICATIONS

This application claims the benefit of U.S. Provisional Patent Application Ser. No. 61/376,803, filed Aug. 25, 2010, titled “Wireless Microphone Apparatuses and Methods” which is hereby expressly incorporated by reference in its entirety.

### FIELD

Various embodiments relate to wireless communications, and more particularly, to methods and apparatus for power control and interference management in a wireless microphone communications system.

### BACKGROUND

Wireless microphone systems often involve manual configuration and control of wireless microphone transmitters and wireless microphone receivers so that individual wireless microphones do not use the same frequency in a particular area and/or to set a transmission power level to be used by a wireless microphone transmitter.

The large amount of manual configuration is not only time consuming but also often results in less than optimal usage of the limited amount of available spectrum due to interference or far from optimal assignments of channels for audio transmission to a wireless microphone receiver.

In addition to configuration issues, with many existing systems, there is no possibility for audio data lost due to transmission problems to be resent and there is also difficulty in monitoring/predicting how much battery life a particular wireless microphone has before it will cease to be able to transmit reliably. There is a need for methods and apparatus which would allow audio data to be retransmitted in the event of a transmission error and would keep track of wireless microphone transmitter remaining battery capacity.

In view of the above discussion, it should be appreciated that there is a need for methods and apparatus for increasing the amount of automatic control and/or configuration of a wireless microphone system.

### SUMMARY

Methods and apparatus for controlling the configuration of a wireless microphone receiver and one or more wireless microphone transmitters are described. In accordance with various embodiments a common control channel is used for communicating control signals between the wireless microphone receiver and one or more wireless microphone transmitters.

The common control channel may be implemented in a frequency division multiplexed manner with a relatively small amount of overall system bandwidth, e.g., less than 10% and in many embodiments less than 5% and in some cases even less than 1% being dedicated for control channel signaling between a wireless microphone receiver and one or more wireless microphone transmitters. While the wireless microphone receiver may communicate control signals to the wireless microphones, in many embodiments the wireless microphone transmitters do not receive audio signals from the wireless microphone receiver. Accordingly, the control channel in many embodiments is simply used for managing one or more audio uplink channels. In some embodiments, what portion of the control channel is to be used for a particular wireless microphone transmitter for the transmission and/or reception of control signals is determined by the wireless microphone receiver and indicated to the individual wireless microphone transmitter. The control signals may include closed loop timing and/or power control signals sent by a wireless microphone receiver and intended for a specific wireless microphone transmitter.

While a frequency division multiplexed channel is used as the control channel in some embodiments, in other embodiments a time division multiplexed approach to the control channel is implemented. In such an embodiment the time dedicated for transmission of wireless microphone receiver to wireless microphone transmitter signals is relatively small compared to the time dedicated for control/data signals from the wireless microphone transmitters to the wireless microphone receiver. For example, less than 1%, 5% or 10% of the total available transmission time may be dedicated for control signaling used for transmission of control signals to wireless microphone transmitters. Such an approach reflects that most of the communications resources are dedicated to be used for audio data communications from the wireless microphone transmitters to the wireless microphone receiver, and the control data signaling from the wireless microphone receiver to the wireless microphone transmitters are dedicated only a very small portion of overall available air link resources. Thus control data signaling from the wireless microphone receiver to the wireless microphone transmitters represents a very small portion of overall communications throughput.

Via the common control channel which can be used to communicate with all or individual wireless microphone transmitters, a wireless microphone receiver can transmit power control and/or closed loop symbol timing control signals to wireless microphone transmitters. Other control signals may include a control signal used to mute an individual one of a plurality of wireless microphone transmitters. The presence of the control channel also allows for repeat transmission requests to be sent to wireless microphone transmitters in response to detecting an error in received audio data. The microphone transmitters, in some embodiments, buffer audio data for a short period of time to facilitate repeat transmission in response to a request and/or negative acknowledgment. In addition to mute and repeat transmission signals to wireless microphone transmitters, the control channel can be, and in some embodiments is, used by wireless microphone transmitters to report their battery status to the wireless microphone receiver which can alert a system operator to the fact that a wireless microphone transmitter may have a limited amount of battery time remaining unless action is taken to replace or recharge the battery. This reduces the need to have users of the wireless microphones monitor battery status.

Through the use of the control channel various other features and control signals are also possible.

An exemplary method of operating a wireless microphone receiver, in accordance with some embodiments, comprises: transmitting wireless microphone transmitter control signals on a control channel corresponding to a first frequency band to control wireless microphone transmitter operation; receiving at least one control signal from a first wireless microphone transmitter communicated on said control channel in said first frequency band; and receiving audio signals from said first wireless microphone transmitter transmitted on an audio data channel in a second frequency band, said second frequency band being lower in frequency than said first frequency band.

An exemplary wireless microphone receiver, in accordance with some embodiments, comprises: at least one processor configured to: transmit wireless microphone transmitter control signals on a control channel corresponding to a first frequency band to control wireless microphone transmitter operation; receive at least one control signal from a first wireless microphone transmitter communicated on said control channel in said first frequency band; and receive audio signals from said first wireless microphone transmitter transmitted on an audio data channel in a second frequency band, said second frequency band being lower in frequency than said first frequency band. The exemplary wireless microphone receiver further comprises a memory coupled to the at least one processor.

An exemplary method of operating a wireless microphone receiver, in accordance with another embodiment, comprises: receiving audio signals during predetermined microphone transmit time periods; and transmitting control signals during predetermined microphone control time periods.

An exemplary wireless microphone receiver, in accordance with some embodiments, comprises: at least one processor configured to: receive audio signals during predetermined microphone transmit time periods; and transmit control signals during predetermined microphone control time periods. The exemplary wireless microphone receiver further comprises a memory coupled to the at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 illustrates an exemplary wireless microphone communications system, in accordance with various exemplary embodiments.

FIG. 2 illustrates an exemplary time frequency structure of channels in accordance with various exemplary embodiments.

FIG. 3 is a flowchart of an exemplary method of operating a wireless microphone receiver, in accordance with various exemplary embodiments.

FIG. 4 is an exemplary wireless microphone receiver device in accordance with an exemplary embodiment.

FIG. 5 is an assembly of modules which may be used in the exemplary wireless microphone receiver device of FIG. 4 in various embodiments.

FIG. 6 illustrates exemplary wireless microphone receiver device communicating with a plurality of wireless microphone transmitters devices in accordance with an exemplary embodiment.

FIG. 7 illustrates an exemplary timing frequency structure in accordance with an exemplary embodiment.

FIG. 8 illustrates exemplary mapping of exemplary signaling of FIG. 6 into the timing frequency structure of FIG. 7 in accordance with exemplary channel assignments.

FIG. 9 illustrates an exemplary time frequency structure of channels in accordance with various exemplary embodiments.

FIG. 10 is a flowchart of an exemplary method of operating a wireless microphone receiver, in accordance with various exemplary embodiments.

FIG. 11 is an exemplary wireless microphone receiver device in accordance with an exemplary embodiment.

FIG. 12 is an assembly of modules which may be used in the exemplary wireless microphone receiver device of FIG. 11 in various embodiments.

FIG. 13 illustrates an exemplary wireless microphone receiver device communicating with a plurality of wireless microphone transmitters devices in accordance with an exemplary embodiment.

FIG. 14 illustrates an exemplary timing frequency structure in accordance with an exemplary embodiment.

FIG. 15 illustrates exemplary mapping of exemplary signaling of FIG. 13 into the timing frequency structure of FIG. 14 in accordance with exemplary subband assignments.

### DETAILED DESCRIPTION

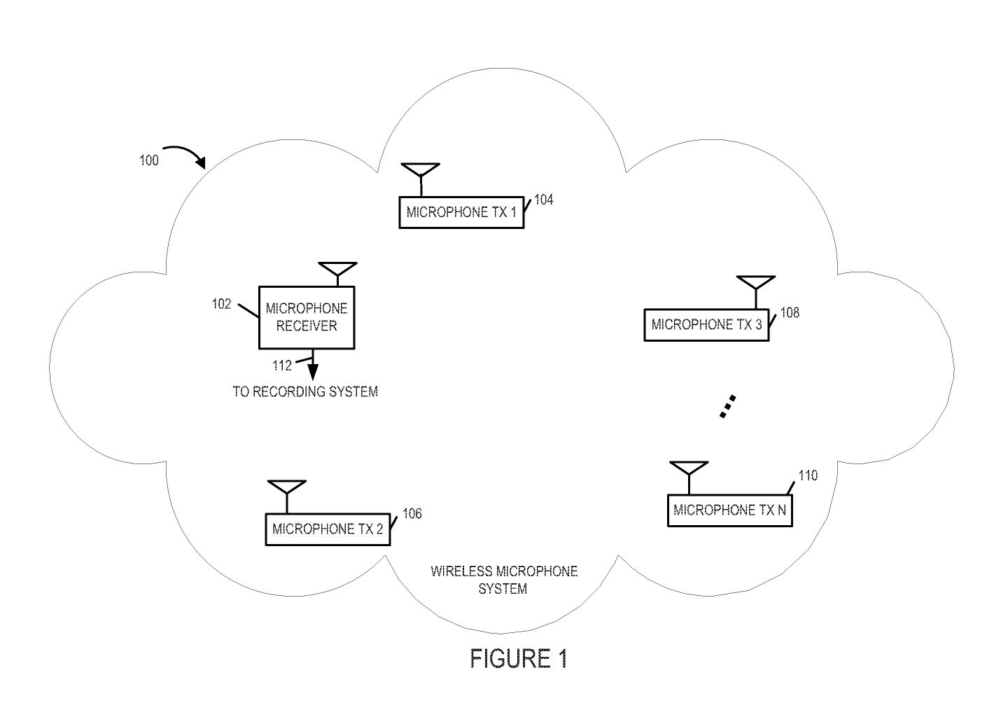

FIG. 1 is a drawing of an exemplary wireless microphone system 100, in accordance with an exemplary embodiment. Exemplary wireless microphone system 100 includes a plurality of wireless microphone devices, e.g., wireless microphone receivers and microphone transmitters. Wireless microphone transmitters are sometimes simply referred to as wireless microphones. In the exemplary system 100 illustrated in FIG. 1, a single wireless microphone receiver 102 is shown serving a plurality of wireless microphone transmitters (wireless microphone transmitter 1 104, wireless microphone transmitter 2 106, wireless microphone transmitter 3 108, . . . , wireless microphone transmitter N 110). Although a single wireless microphone receiver 102 is shown, it should be appreciated that multiple microphone receivers may, and in some embodiments are, used in the system 100 and may be located at different locations. Wireless microphone transmitters (104, 106, 108, . . . , 110) in system 100 transmit and/or receive signals, e.g., audio signals, control signals, feedback signals etc., to and/or from the wireless microphone receiver 102. The wireless microphone receiver 102 communicates with various wireless microphone transmitters in the system, e.g., via wireless links. The wireless microphone receiver 102 provides access to a recording system and/or other network resources, via link 111, e.g., a wired or fiber network connection.

In accordance with one feature of some embodiments, wireless microphone receiver 102 transmits control signals on a control channel corresponding to a first frequency band to control wireless microphone transmitter operation and receives at least one control signal from a wireless microphone transmitter in the system, e.g., wireless microphone transmitter 104, on the same control channel but in different predetermined time slots. Thus in some embodiments the control channel is used in a time division duplexed manner. In some such embodiments, the wireless microphone receiver 102 receives audio signals from the microphone transmitter 104 transmitted on an audio data channel in a second frequency band.

In accordance with one aspect of some other embodiments, time division multiplexing (TDM) of a first frequency band is implemented for communicating control and audio signals during different time periods. In one such embodiment, during predetermined time periods the first frequency band is used for receiving audio traffic signals and/or control feedback information from the wireless microphone transmitters in the system 100. In accordance with one aspect of some such embodiments there is no transmission of control signals from the wireless microphone receiver 102 during the time periods when the first frequency band is used for receiving audio traffic signals and/or control feedback information.

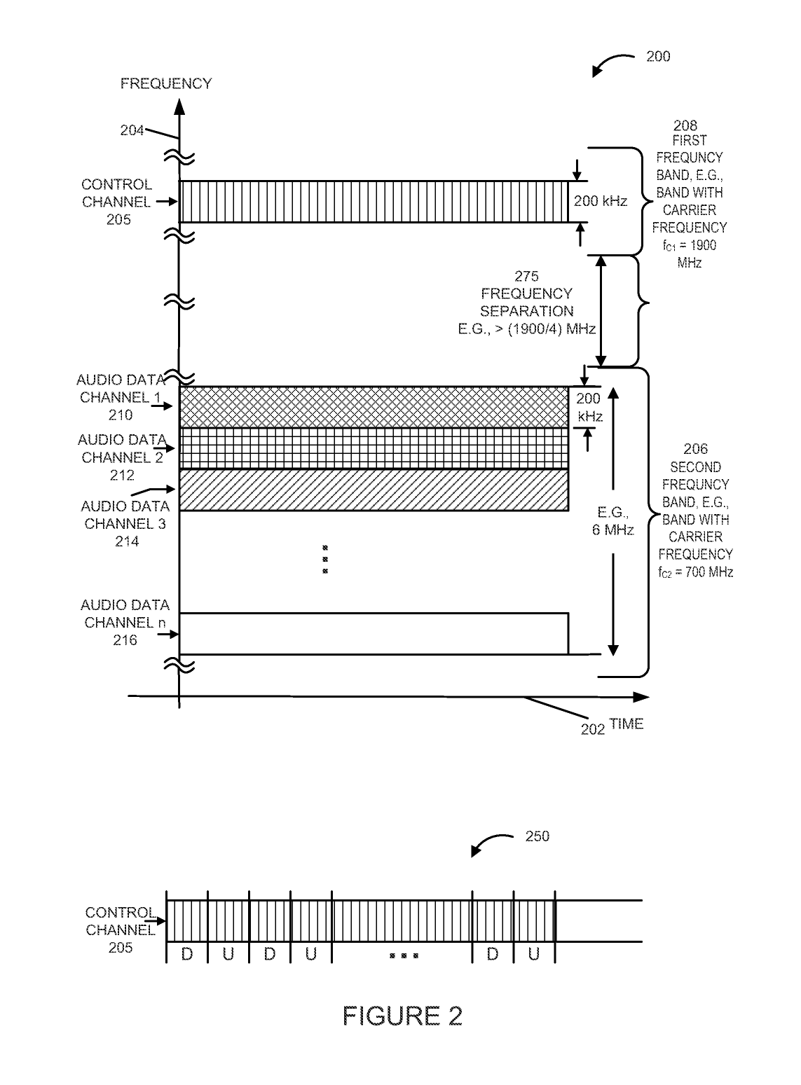

FIG. 2 illustrates an exemplary time frequency structure of exemplary communications channels which can be used for microphone communications, e.g., microphone audio data and control signaling communications, in exemplary wireless microphone system 100 of FIG. 1. In drawing 200 of FIG. 2, the horizontal axis 202 represents time and the vertical axis 204 represents frequency. FIG. 2 illustrates an example of frequency division multiplexing (FDM) between control channel and audio traffic channels. The exemplary time frequency structure of drawing 200 includes a frequency band 206 used for audio data channels and a frequency band 208 used for the control channel. The first frequency band is, e.g., a frequency band with carrier frequency f_{C1}=1900 MHz. The second frequency band is, e.g., a frequency band with carrier frequency f_{C2}=700 MHz. Frequency band 206 includes a plurality of communications channels which can be used for wireless microphone communications, e.g., for communicating audio traffic signals from the wireless microphone transmitters to the wireless microphone receiver 102, in accordance with some exemplary embodiments. Frequency band 206 includes a plurality of audio traffic communications channels including audio data channel 1 210, audio data channel 2 212 audio data channel 3 214, . . . , audio data channel N 216. In this example each audio data channel is a 200 kHz channel. Signals of the audio data channel may be modulated on the carrier frequency of the second frequency band. In some embodiments, an individual wireless microphone transmitter may acquire and use a single audio data channel. In some embodiments, at least some individual wireless microphone transmitters may, and sometimes do, acquire and use multiple audio data channels.

In the FIG. 2 example, there is a separate control channel 205 corresponding to a frequency band 208 which is different than the frequency band 206 used for audio traffic communications. The frequency band 206 corresponding to the various audio traffic channels is lower in frequency than the frequency band 208 corresponding to the control channel 205. In one embodiment the control channel 205 is a 200 kHz frequency channel. Signals of the control channel may be modulated on the carrier frequency of the first frequency band. In some embodiments, different portions of the control channel 205 correspond to different audio data channels. In various embodiments, different non-overlapping time-frequency portions of the control channel correspond to different audio data channels in accordance with a predetermined mapping. The control channel 205 is used by wireless microphone receiver device 102 in the system for transmitting microphone transmitter control signals from the wireless microphone receiver 102 to one or more of the wireless microphone transmitter devices (104, 106, 108, . . . , 110) and for receiving control information from one or more wireless microphone transmitters (104, 106, 108, . . . , 110).

Each communications channel may include one or more tones. In one example within frequency band 206 there are N 200 kHz audio data channels, where N=30, representing a 6 MHz block of channels. In some embodiments each audio data channel includes, e.g., 16 OFDM tones.

It should be appreciated that in some embodiments there is a large frequency separation 275 between the frequency band 208 corresponding to the control channel and the frequency band 206 corresponding to the audio data channels. In some embodiments, the frequency separation between the first frequency band and the second frequency band is larger than the carrier frequency of the first frequency band divided by 4, e.g., the frequency separation is greater than (1900/4) MHz. In the illustrated embodiment the control channel 205 and audio data traffic channels (210, 212, 214, . . . , 216) correspond to different frequency bands, thus the control signals and audio data signals can be received at the same time without interfering with each other.

In accordance with one feature of some embodiments, the wireless microphone transmitters (104, 106 108, . . . , 110) communicate audio data to the wireless microphone receiver 102 using an assigned communications channel, e.g., with each of the channels (210, 212, 214, . . . , 216) being assigned to a different wireless microphone at a given time. The control channel 205, in some embodiments, is a time division duplexed channel and is used in some embodiments for (i) transmission of control signals to the wireless microphone transmitters in predetermined time slots dedicated for transmissions from the wireless microphone receiver 102, and (ii) receiving at least one control signal in a predetermined time slot dedicated for receiving control signals from a wireless microphone transmitter e.g., the first wireless microphone 104. Thus in some embodiments the wireless microphone receiver 102 transmits a wireless microphone control signal on the control channel 205, e.g., during a predetermined time slot reserved for transmission of control information from the wireless microphone 102, while it receives a control signal from a wireless microphone, e.g., during a predetermined time slot reserved for receiving control information from wireless microphones. In accordance with one aspect, the wireless microphone receiver 102 also receives audio signals from a wireless microphone on audio data channel in the frequency band 206 which is lower in frequency than the frequency band 208 corresponding to the control channel 205.

Drawing 250 of FIG. 2 illustrates a more detailed representation of exemplary control channel 205 in accordance with some embodiments. In this example, control channel 205 includes: (i) slots used for control signaling from the wireless receiver device to one or more wireless transmitter devices, which are designated as “D slots” for downlink, and (ii) slots used for control signaling from the wireless transmitter devices to the wireless receiver device which are designated as “U slots” for uplink.

Lower RF frequencies tend to be more reliable than high RF frequencies for a given transmit power and coding rate. It should be appreciated that the majority of the communication in the wireless microphone system is used for transmission of audio data to a wireless microphone receiver. It should also be appreciated that wireless microphone receivers are, in many embodiments, stationary devices with access to AC power lines while wireless microphone transmitters are often battery powered devices. Taking these various factors into account, in at least some embodiments, lower RF frequencies are used for audio data transmission while higher RF frequencies are used for control signaling to/from wireless microphone transmitters. In this way, wireless microphone transmitters can make the most of their limited available transmit power by using the more reliable lower RF frequencies for the transmission of audio data allowing lower power and/or a lower amount of error correction coding to achieve reliable communication than would be required if higher frequency RF signals were used to communicate the audio data. While control signals are sent using the higher RF frequency band, many of the control signals are transmitted by the wireless microphone receiver which is less power constrained that the individual wireless microphone transmitters since the wireless microphone receiver is normally not limited to battery power. In addition, since the amount of control signaling is relativity small in the system, a higher degree of error correcting coding can be used for the control signaling without significantly impacting the amount of audio data which can be communicated using the limited available frequency resources.

By maintaining a large frequency separation between control signals and audio data signals, the chance of interference between the signals is minimized and in some embodiments, control and audio data communication may occur at the same time. For example, the wireless microphone receiver may transmit control signals and/or control information while one or more wireless microphone transmitters are simultaneously transmitting audio data to the wireless microphone receiver.

In some but not necessarily all embodiments, a wireless microphone transmitter transmit control information to the wireless microphone receiver using a higher transmission power level and/or level of error correcting coding than it uses for transmitting audio data to the wireless microphone transmitter. In some embodiments, the wireless microphone receiver transmits control signaling and/or control information to a wireless microphone transmitter using a transmit power level that is higher than the transmit power level used by the particular wireless microphone transmitter for transmitting control information and/or audio data to the wireless microphone receiver.

In many embodiments while the wireless microphone receivers may wirelessly transmit timing, power control and/or control signals or information over wireless links, in at least some embodiments the wireless microphone transmitters do not wirelessly transmit audio data to any device. In at least some such embodiments a wire or optical line is used to relay received audio information to a recording or other system. However, in other embodiments the wireless microphone receivers may wirelessly transmit audio data received from the wireless microphone transmitters to a recorder or some other device which is not a wireless microphone transmitter.

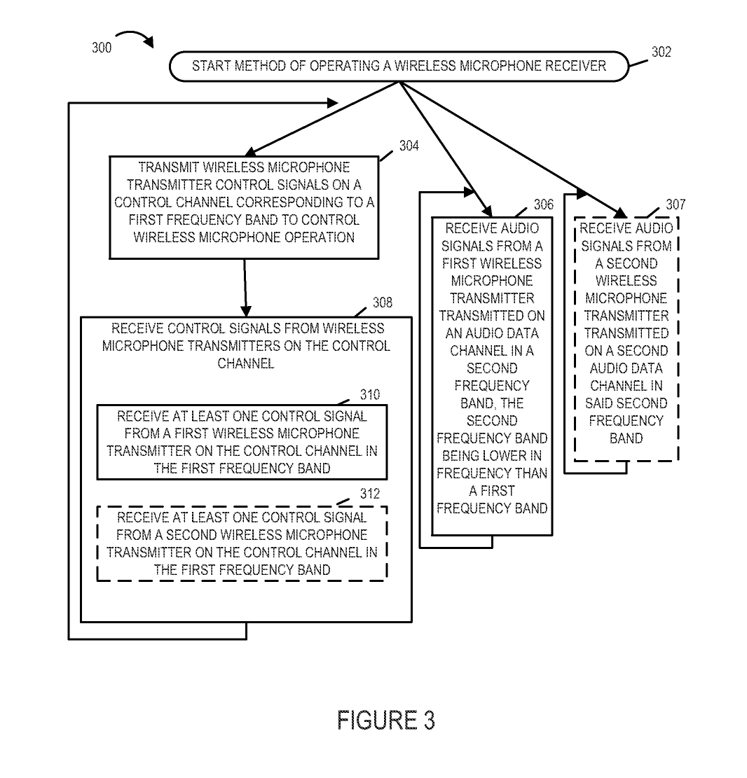

FIG. 3 illustrates a flowchart 300 of an exemplary method of operating a wireless microphone receiver, in accordance with various exemplary embodiments. The wireless microphone receiver implementing the method of flowchart 300 is, e.g., wireless microphone receiver 102 of wireless microphone system 100 of FIG. 1. As will be discussed, in accordance with one feature of various embodiments, the wireless microphone receiver transmits and receives control signals on a control channel corresponding to a first frequency band, and receives audio data signals from wireless microphones on audio data channels corresponding to a second frequency band which is lower in frequency than the first frequency band.

The exemplary method of flowchart 300 starts in step 302, where the wireless microphone receiver is powered on and initialized. Operation proceeds from start step 302 to steps 304 and 306. Operation may, and sometimes does, also proceed from step 302 to step 307.

In step 304 the wireless microphone receiver transmits wireless microphone control signals on a control channel, e.g., control channel 205, corresponding to a first frequency band, e.g., band 208, to control wireless microphone transmitter operation. In various embodiments transmitting wireless microphone control signals on a control channel in step 304 includes transmitting at least one control signal on the control channel to a first wireless microphone transmitter, e.g., wireless microphone transmitter device 1 104. Step 304 may, and sometimes does, include transmitting at least one control signal on the control channel to a second wireless microphone transmitter, e.g., wireless microphone transmitter device 2 106. In some embodiments the wireless microphone receiver transmits the control signals on the control channel in predetermined time slots dedicated for transmission from the wireless microphone receiver. Operation proceeds from step 304 to step 308.

In step 308 the wireless microphone receiver receives control signals from wireless microphone transmitters on the control channel. In some embodiments, the control signals from the wireless microphone transmitters are received in predetermined time slots dedicated for receiving control signals from wireless microphone transmitters. Step 308 includes step 310 in which the wireless microphone receiver receives at least one control signal from the first wireless microphone transmitter, e.g., wireless transmitter 1 104 on the control channel in the first frequency band. Step 308 may, and sometimes does, include step 312 in which the wireless receiver device receives at least one control signal from a second wireless microphone transmitter, e.g., wireless transmitter 2 106, on the control channel in the first frequency band. Steps 310 and 312 may be performed serially or in parallel depending upon the timing frequency structure implemented. Operation proceeds from step 308, to step 304, where the wireless microphone device transmits additional control signals on the control channel.

In some embodiments the first frequency band is a 1900 MHz frequency band, e.g., a frequency band using a carrier of 1900 MHz. In some embodiments the control channel is a common control channel used in a time shared manner and is used for both transmitting control signals to one or more wireless microphone transmitters and for receiving control signals from the one or more wireless microphone transmitters in predetermined time slots dedicated for transmitting and receiving control signals, respectively. In one embodiment the control channel is a 200 kHz frequency bandwidth channel.

Returning to step 306, in step 306 the wireless microphone receiver receives audio signals from the first wireless microphone transmitter, e.g., transmitter device 1 104, transmitted on an audio data channel, e.g., audio data channel 1 210, in a second frequency band, e.g., band 206, the second frequency band being lower in frequency than the first frequency band, e..g, band 208, to which the control channel corresponds. Step 306 is repeated on an ongoing basis.

Returning to step 307, in step 307 the wireless microphone receiver receives audio signals from the second wireless microphone transmitter, e.g., wireless transmitter device 2 106, transmitted on an audio data channel, e.g., audio data channel 2 212, in a second frequency band, e.g., band 206, the second frequency band being lower in frequency than the first frequency band, e.g., band 208, to which the control channel corresponds. Step 307 is repeated on an ongoing basis.

It should be appreciated from FIG. 2 example, that exemplary control channel 205 corresponds to a frequency band 208 which is higher in frequency than the audio data channel frequency band 206 which is shown below the control channel frequency band 208 on the frequency axis 204 in FIG. 2. In various embodiments, the first and second frequency bands are radio frequency bands. In some embodiments the second frequency band is a 700 MHz frequency band, e.g., a frequency band using a carrier of 700 Mhz. In some embodiments the second frequency band corresponding to the audio data channels is separated from the first frequency band by more than a frequency width greater and ¼ of the first frequency band carrier frequency. For example, in FIG. 2 the frequency separation, designated by reference number 275, between the first frequency band 208 and second frequency band 206 is more than ¼ the carrier frequency of the first frequency band 208, e.g., the separation is greater than 1900/4 MHz.

The wireless microphone receiver may, and sometimes does, communicate with more than two wireless microphone transmitter devices. For example, the wireless receiver device may transmit control signals to M wireless transmitter devices, receive control signals from the M wireless microphone transmitter devices and receive audio signals from the M wireless microphone transmitter devices, where M is a number greater than 2 and less than or equal to N, where N is the total number of audio data channels in the second frequency band. Each of the M wireless devices may use a different audio data channel.

In some embodiments, the wireless receiver device may, and sometimes does, receive control signals and audio data signals at the same time. For example, the wireless microphone receiver device, e.g., device 102, may receive a control signal from wireless transmitter device 1 104 in control channel 205 of band 208 while simultaneously receiving audio data signals from wireless transmitter device 1 104 in audio data channel 1 210 of frequency band 206. As another example, the wireless microphone receiver device, e.g., device 102, may receive a control signal from wireless transmitter device 1 104 in control channel 205 of band 208 while simultaneously receiving audio data signals from wireless transmitter device 2 106 in audio data channel 2 212 of frequency band 206. As yet another example, the wireless microphone receiver device, e.g., device 102, may receive the following simultaneously: (i) a control signal from wireless transmitter device 1 104 in control channel 205 of band 208, (ii) audio data signals from wireless transmitter device 1 104 in audio data channel 1 210 of frequency band 206, (iii) a control signal from wireless transmitter device 2 106 in control channel 205 of band 208, (iv) audio data signals from wireless transmitter device 2 106 in audio data channel 2 212 of frequency band 206.

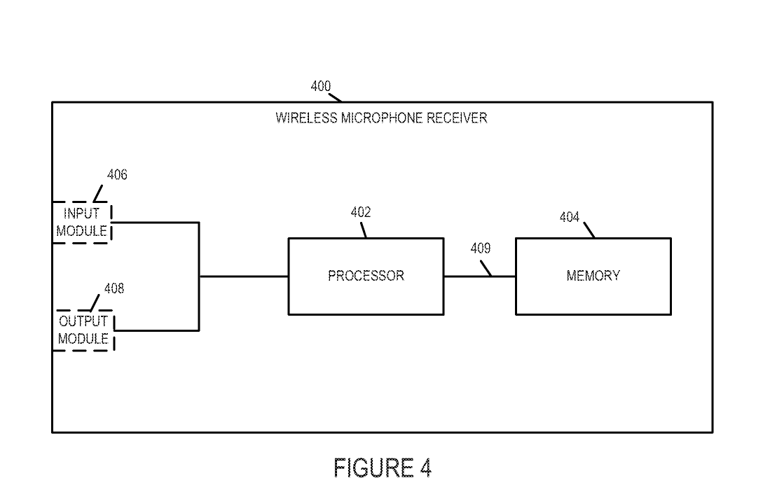

FIG. 4 is a drawing of an exemplary wireless microphone receiver 400, in accordance with an exemplary embodiment. Exemplary wireless microphone receiver 400 may be used as the wireless microphone receiver 102 of system 100 of FIG. 1. Exemplary wireless microphone receiver 400 may, and sometimes does, implement a method in accordance with flowchart 300 of FIG. 3.

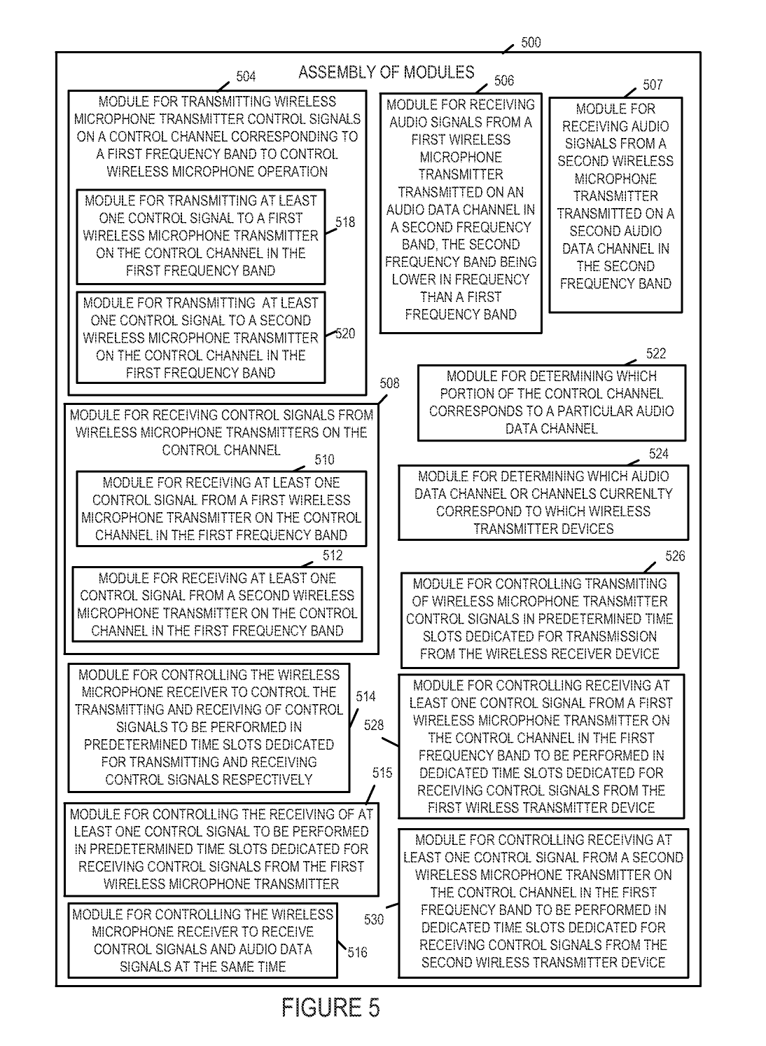

The wireless microphone receiver 400 includes a processor 402 and memory 404 coupled together via a bus 409 over which the various elements (402, 404) may interchange data and information. The memory 404 may include an assembly of modules used to control the wireless microphone receiver 400, e.g., such as the assembly of modules shown in FIG. 5. The wireless microphone receiver 400 further includes an input module 406 and an output module 408 which may be coupled to processor 402 as shown. However, in some embodiments, the input module 406 and output module 408 are located internal to the processor 402. Input module 406 can receive input signals. Input module 406 can, and in some embodiments does, include a wireless receiver and/or a wired or optical input interface for receiving input. Output module 408 may include, and in some embodiments does include, a wireless transmitter and/or a wired or optical output interface for transmitting output.

In various embodiments, processor 402 is configured to: transmit wireless microphone transmitter control signals on a control channel corresponding to a first frequency band to control wireless microphone transmitter operation; receive at least one control signal from a first wireless microphone transmitter communicated on said control channel in said first frequency band; and receive audio signals from said first wireless microphone transmitter transmitted on an audio data channel in a second frequency band, said second frequency band being lower in frequency than said first frequency band. In some embodiments, the first and second frequency bands are both radio frequency bands. In some embodiments, the second frequency band is separated from said first frequency band by more than the frequency width of said first frequency band. In various embodiments, the first frequency band is a 1900 MHz frequency band. In some embodiments, the second frequency band is a 700 MHz frequency band.

In some embodiments, the control channel is a time division duplexed channel, and processor 402 is further configured to control the transmission of the wireless microphone transmitter control signals to be performed in predetermined time slots dedicated for transmissions from said wireless microphone receiver. In some embodiments, the control channel is a time division duplexed channel, and processor 402 is further configured to control the receiving of said at least one control signal to be performed in predetermined time slots dedicated for receiving control signals from said first wireless microphone transmitter.

In some embodiments, processor 402 is configured to receive control signals and audio data at the same time.

FIG. 5 illustrates an assembly of modules 500 which can, and in some embodiments is, used in a wireless microphone receiver such as the wireless microphone receiver 400 illustrated in FIG. 4 and/or wireless microphone receiver 102 of FIG. 1. The modules in the assembly of modules 400 can be implemented in hardware within the processor 402 of FIG. 4, e.g., as individual circuits. Alternatively, the modules may be implemented in software and stored in the memory 404 of the wireless microphone receiver 400 shown in FIG. 4. While shown in the FIG. 4 embodiment as a single processor, e.g., computer, it should be appreciated that the processor 402 may be implemented as one or more processors, e.g., computers.

When implemented in software the modules include code, which when executed by the processor, configure the processor, e.g., computer, 402 to implement the function corresponding to the module. In some embodiments, processor 402 is configured to implement each of the modules of the assembly of modules 500. In embodiments where the assembly of modules 500 is stored in the memory 404, the memory 404 is a computer program product comprising a computer readable medium comprising code, e.g., individual code for each module, for causing at least one computer, e.g., processor 402, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 5 control and/or configure the wireless microphone receiver 400 or elements therein such as the processor 402, to perform the functions of the corresponding steps illustrated and/or described in the method of flowchart 300 of FIG. 3.

Assembly of modules 500 includes a module for transmitting wireless microphone transmitter control signals on a control channel corresponding to a first frequency band to control wireless microphone operation 504, a module for receiving control signals from wireless microphone transmitters on the control channel 508, a module for receiving audio signals from a first wireless microphone transmitter transmitted on an audio data channel in a second frequency band, the second frequency band being lower in frequency than the first frequency band 506 and a module for receiving audio signals from a second wireless microphone transmitter transmitted on a second audio data channel in a second frequency band the second frequency band being lower in frequency than the first frequency band 507. Module 504 includes a module for transmitting at least one control signal to a first wireless microphone transmitter on the control channel in the first frequency band 518 and a module for transmitting at least one control signal to a second wireless microphone transmitter on the control channel in the first frequency band 520. Module 508 includes a module for receiving at least one control signal from a first wireless microphone transmitter on the control channel in the first frequency band 510 and a module for receiving at least one control signal from a second wireless microphone transmitter on the control channel in the first frequency band 512.

Assembly of modules 500 further includes a module for controlling the wireless microphone receiver to control the transmitting and receiving of control signals to be performed in predetermined time slots dedicated for transmitting and receiving control signals respectively 514, a module for controlling said receiving of at least one control signal to be performed in predetermined time slots dedicated for receiving control signals from the first wireless microphone transmitter 515, and a module for controlling the wireless microphone receiver to received control signals and audio data signals at the same time 516. Assembly of modules 500 further includes a module for determining which portion of the control channel corresponds to a particular audio data channel 522 and a module for determining which audio data channel or channels currently correspond to which wireless transmitter microphone devices 524.

Assembly of modules 500 further includes a module for controlling transmitting of wireless microphone control signals in predetermined time slots dedicated for transmission from the wireless receiver device 526, a module for controlling receiving at least one control signal from a first wireless microphone transmitted on the control channel in the first frequency band to be performed in dedicated time slots dedicated for receiving control signals from the first wireless microphone transmitter device 528, and a module for controlling receiving at least one control signal from a second wireless microphone transmitter on the control channel in the first frequency band to be performed in dedicated time slots dedicated for receiving control signals form the second wireless transmitter device 530.

In various embodiments, the first and second frequency bands are both radio frequency bands. In some embodiments, the control channel is a time division duplexed channel, and module 526 controls said transmitting to be performed in predetermined time slots dedicated for transmissions from said wireless microphone receiver. In various embodiments, said control channel is a time division duplexed channel, and module 528 controls said receiving of at least one control signal to be performed in predetermined time slots dedicated for receiving control signals from said first wireless microphone transmitter.

In various embodiments, said second frequency band is separated from said first frequency band by more than the ¼ the carrier frequency of said first frequency band. In some embodiments, the first frequency band is a 1900 MHz frequency band. In some such embodiments, said second frequency band is a 700 MHz frequency band.

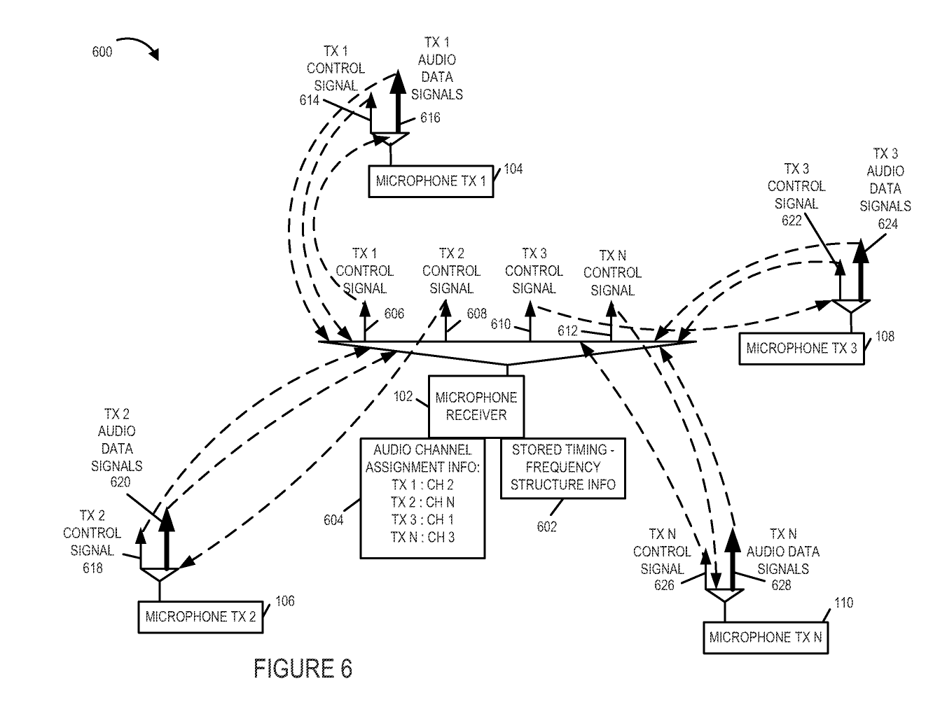

FIGS. 6-9 illustrate an example, in which an exemplary wireless microphone receiver implements a method in accordance with flowchart 300 of FIG. 3. Drawing 600 of FIG. 6 illustrates exemplary wireless microphone receiver 102 communicating with a plurality of wireless microphone transmitters (wireless microphone transmitter 1 104, wireless microphone transmitter 2 106, wireless microphone transmitter 3 108, and wireless microphone transmitter N 110). Wireless microphone receiver 102 includes stored timing frequency structure information 602 in its memory. Wireless microphone receiver 102 has determined audio channel assignment information 604 which identifies that: wireless microphone transmitter device 1 104 is currently assigned audio data channel 2, wireless microphone transmitter device 2 106 is currently assigned audio data channel N, wireless microphone transmitter device 3 108 is currently assigned audio data channel 1, and wireless microphone transmitter device N 110 is currently assigned audio data channel 3. The wireless receiver device uses the audio channel assignment information and stored timing—frequency structure information 602 to identify the air link resources corresponding to the control signaling and audio data signaling corresponding to the different wireless transmitter devices.

Wireless microphone receiver 102 generates and transmits control signals (wireless microphone transmitter 1 control signal 606, wireless microphone transmitter 2 control signal 608, wireless microphone transmitter 3 control signal 610, wireless microphone transmitter N control signal 612) to wireless microphone transmitters (104, 106, 108, 110), respectively. Each of the wireless microphone transmitters (104, 106, 108, 110) generates and transmits control signals and audio data channel signals. Wireless microphone receiver 102 receives control signal 614 and audio data signals 616 from wireless microphone transmitter 1 104. Wireless microphone receiver 102 receives control signal 618 and audio data signals 620 from wireless microphone transmitter 2 106. Wireless microphone receiver 102 receives control signal 622 and audio data signals 624 from wireless microphone transmitter 3 108. Wireless microphone receiver 102 receives control signal 626 and audio data signals 628 from wireless microphone transmitter N 110.

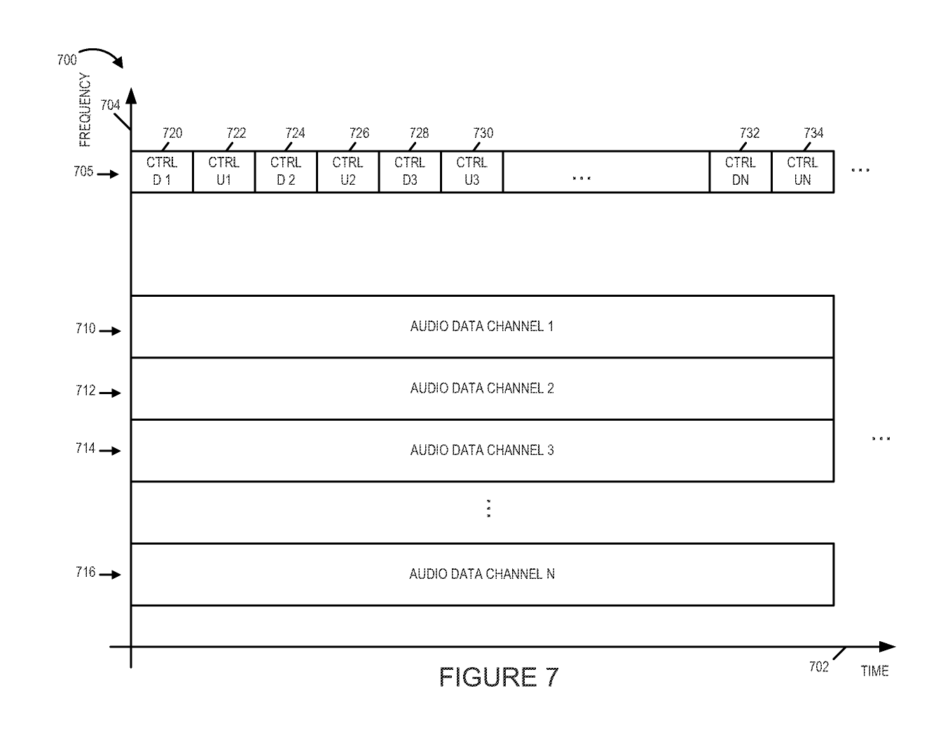

Drawing 700 of FIG. 7 illustrates an exemplary timing frequency structure, which may represent the stored timing frequency structure information 602 of FIG. 6. Horizontal axis 702 represents time and vertical axis 704 represents frequency. The control channel 705 is partitioned into a plurality of dedicated resources. Resource 720 corresponds to a first time slot and is used for conveying a control channel signal in the downlink from the wireless microphone receiver device to the wireless microphone transmitter device which is currently assigned to use audio data channel 1. Resource 722 corresponds to a second time slot and is used for conveying a control channel signal in the uplink from the wireless microphone transmitter device which is currently assigned to use audio data channel 1 to the wireless microphone receiver device. Resource 724 corresponds to a third time slot and is used for conveying a control channel signal in the downlink from the wireless microphone receiver device to the wireless microphone transmitter device which is currently assigned to use audio data channel 2. Resource 726 corresponds to a fourth time slot and is used for conveying a control channel signal in the uplink from the wireless microphone transmitter device which is currently assigned to use audio data channel 2 to the wireless microphone receiver device. Resource 728 corresponds to a fifth time slot and is used for conveying a control channel signal in the downlink from the wireless microphone receiver device to the wireless microphone transmitter device which is currently assigned to use audio data channel 3. Resource 730 corresponds to a sixth time slot and is used for conveying a control channel signal in the uplink from the wireless microphone transmitter device which is currently assigned to use audio data channel 3 to the wireless microphone receiver device. Resource 732 corresponds to a (2N−1)th time slot and is used for conveying a control channel signal in the downlink from the wireless microphone receiver device to the wireless microphone transmitter device which is currently assigned to use audio data channel N. Resource 734 corresponds to a (2N)th time slot and is used for conveying a control channel signal in the uplink from the wireless microphone transmitter device which is currently assigned to use audio data channel N to the wireless microphone receiver device.

The timing frequency structure of FIG. 7 also includes audio data channel 1 710, audio data channel 2 712, audio data channel 3 714, . . . , audio data channel N 716. In one exemplary embodiment, control channel 705 of FIG. 7 is control channel 205 of FIG. 2; and audio data channels (710, 712, 714, . . . , 716) of FIG. 7 are audio data channels (210, 212, 214, . . . , 216) of FIG. 2.

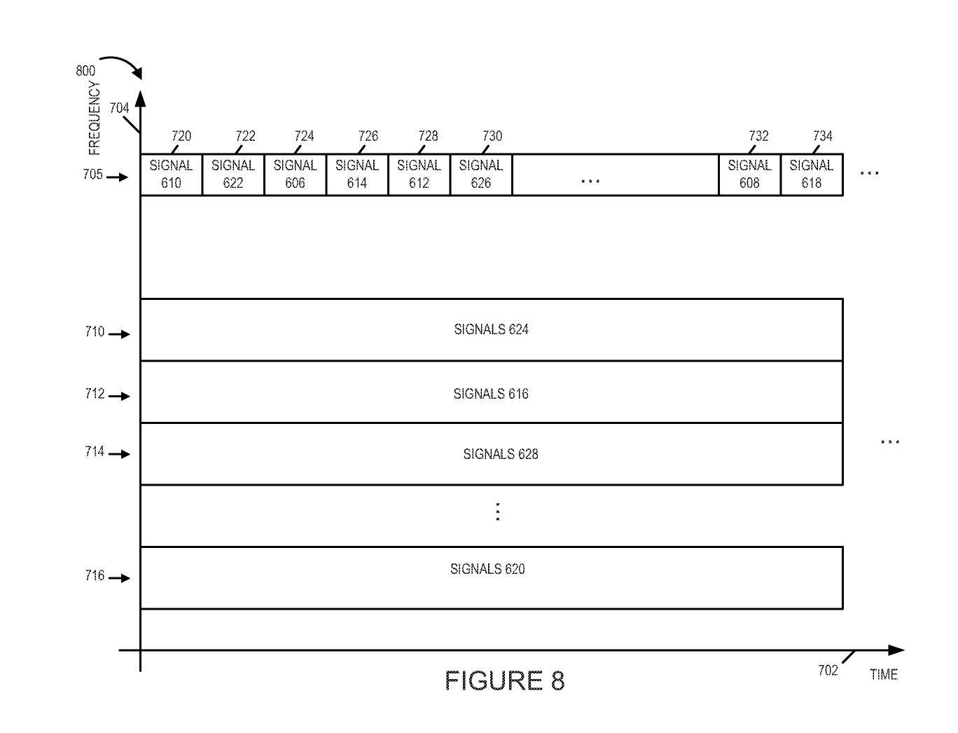

Drawing 800 of FIG. 8 illustrates which air link resources of FIG. 7 are used to convey the various signals of FIG. 6 in accordance with the current audio channel assignment information 604 of FIG. 6. Control channel resources (720, 722, 724, 726, 728, 730, 732, 734) convey control signals (610, 622, 606, 614, 612, 626, 608, 618), respectively. Audio data channel resources (710, 712, 714, 716) convey audio data signals (624, 616, 628, 620), respectively.

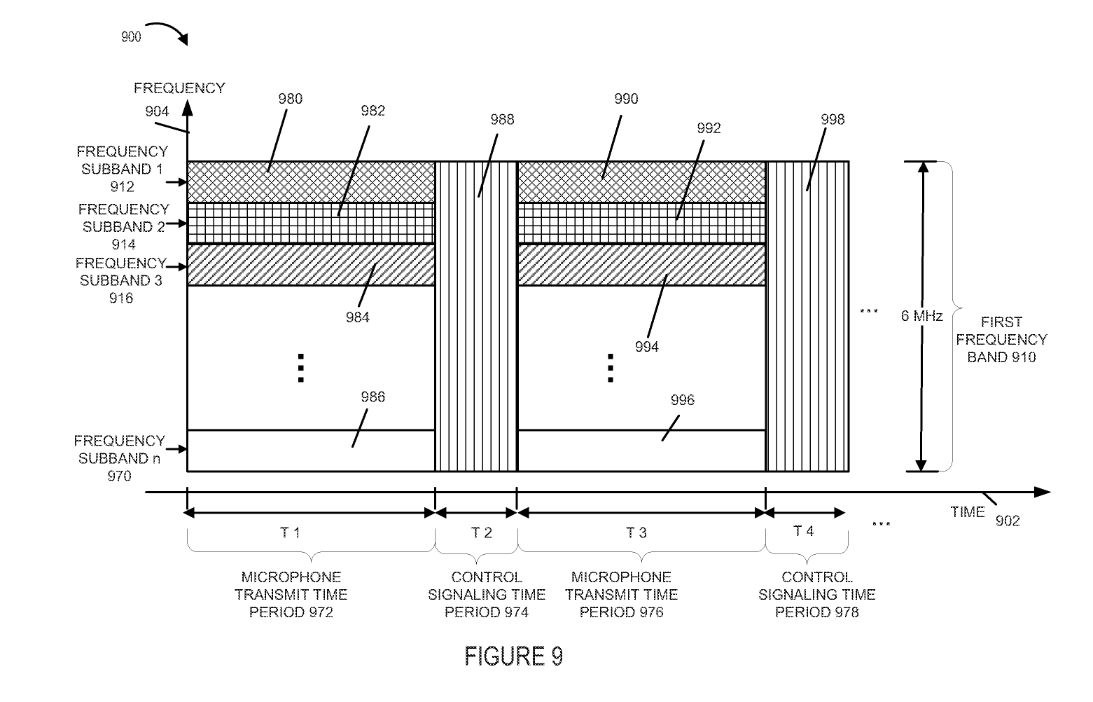

FIG. 9 is a drawing 900 illustrating an exemplary timing frequency structure in accordance with various exemplary embodiments. In FIG. 9, the horizontal axis 902 represents time and the vertical axis 904 represents frequency. The exemplary timing frequency structure of FIG. 9 includes an exemplary first frequency band 910. Exemplary first frequency band 910 is a communications band which can be, and sometimes is, used for microphone communications, e.g., microphone audio data and control signaling communication. First frequency band 910 includes a plurality of non-overlapping frequency subbands (frequency subband 1 912, frequency subband 2 914, frequency subband 3 916, . . . , frequency subband n 970) which can be used for wireless microphone communications, in accordance with some exemplary embodiments.

FIG. 9 illustrates an example of time division multiplexing (TDM) of the first frequency band 910 for communicating control and audio signals during different time periods. In the example of FIG. 9, during predetermined time periods sometimes referred to as microphone transmit time periods, e.g., such as exemplary time period T1 972 and exemplary time period T3 976, the first frequency band 910 is used for receiving audio traffic signals and/or control feedback information from the wireless microphone transmitters, e.g., wireless microphone transmitter 1 104, wireless microphone transmitter 2 106, wireless microphone transmitter 3 108, . . . , wireless microphone transmitter N 110, in the wireless microphone system, e.g., system 100 of FIG. 1. In accordance with one aspect of various embodiments there is no transmission of control signals from the wireless microphone receiver, e.g., wireless microphone receiver 102, during the microphone transmit time periods, e.g., time period T1 972, time period T3 976.

The first frequency band 910 is divided into a plurality of non-overlapping frequency subbands (912, 914, 916, . . . , 970) which, in some embodiments, may be used by different wireless microphone transmitters for communicating signals to the wireless microphone receiver during microphone transmit time periods, e.g., during time period T1 972 and time period T3 976. In some embodiments, the signals which may be communicated to the wireless microphone receiver during the microphone transmit time periods include audio and control signals. In some other embodiments, the signals which may be communicated to the wireless microphone receiver during the microphone transmit time period include audio signals but do not include control signals.

Each horizontal row (912, 914, 916, . . . , 970) represents an individual frequency subband within the first frequency band 910. Each frequency subband may be assigned to a different wireless microphone transmitter for transmitting signals to the wireless microphone receiver, e.g., device 102, during the microphone transmit time periods such as time period T1 and time period T3. For example, during time period T1 frequency subband 1 912 may be assigned to wireless microphone transmitter 1 104 for transmitting audio traffic to the wireless microphone receiver 102, frequency subband 2 914 may be assigned to wireless microphone transmitter 2 106 for transmitting audio traffic to the wireless microphone receiver 102, etc. Thus in some embodiments different subbands are dedicated, e.g., in accordance with assignments, to different wireless microphone transmitters for communicating with the wireless microphone receiver. In some embodiments, a single wireless microphone transmitter may be, and sometimes is, assigned two or more subbands in first frequency band 910.

During exemplary time period T2 974 and exemplary time period T4 978, referred to as a control signaling time periods, the first frequency band 910 as a whole is dedicated for communication of control signaling information. In one embodiment a control signaling time period, e.g., time period T2 is, e.g., 1 OFDM symbol time period long. For example, in some embodiments every 1 second, one OFDM symbol is reserved for communicating control signaling information. In some embodiments at least some control signaling time periods, such as time T2, are dedicated for transmitting control signals from the wireless microphone receiver, e.g., device 102, to the wireless microphone transmitters, while some other control signaling time periods, e.g., time period T4, are dedicated for receiving control signals from wireless microphone transmitters.

Thus, as illustrated in FIG. 9, the first frequency band 910 is used for wireless microphone control signaling and audio traffic communications during different time periods on a recurring basis.

Block 980 represents exemplary air link resources corresponding to frequency subband 1 912 during time period T1 972. Block 982 represents exemplary air link resources corresponding to frequency subband 2 914 during time period T1 972. Block 984 represents exemplary air link resources corresponding to frequency subband 3 916 during time period T1 972. Block 986 represents exemplary air link resources corresponding to frequency subband n 970 during time period T1 972. Block 988 represents exemplary air link resources corresponding to first frequency band 910 during time period T2 974.

Block 990 represents exemplary air link resources corresponding to frequency subband 1 912 during time period T3 976. Block 992 represents exemplary air link resources corresponding to frequency subband 2 914 during time period T3 976. Block 994 represents exemplary air link resources corresponding to frequency subband 3 916 during time period T3 976. Block 996 represents exemplary air link resources corresponding to frequency subband n 970 during time period T3 976. Block 998 represents exemplary air link resources corresponding to first frequency band 910 during time period T4 978.

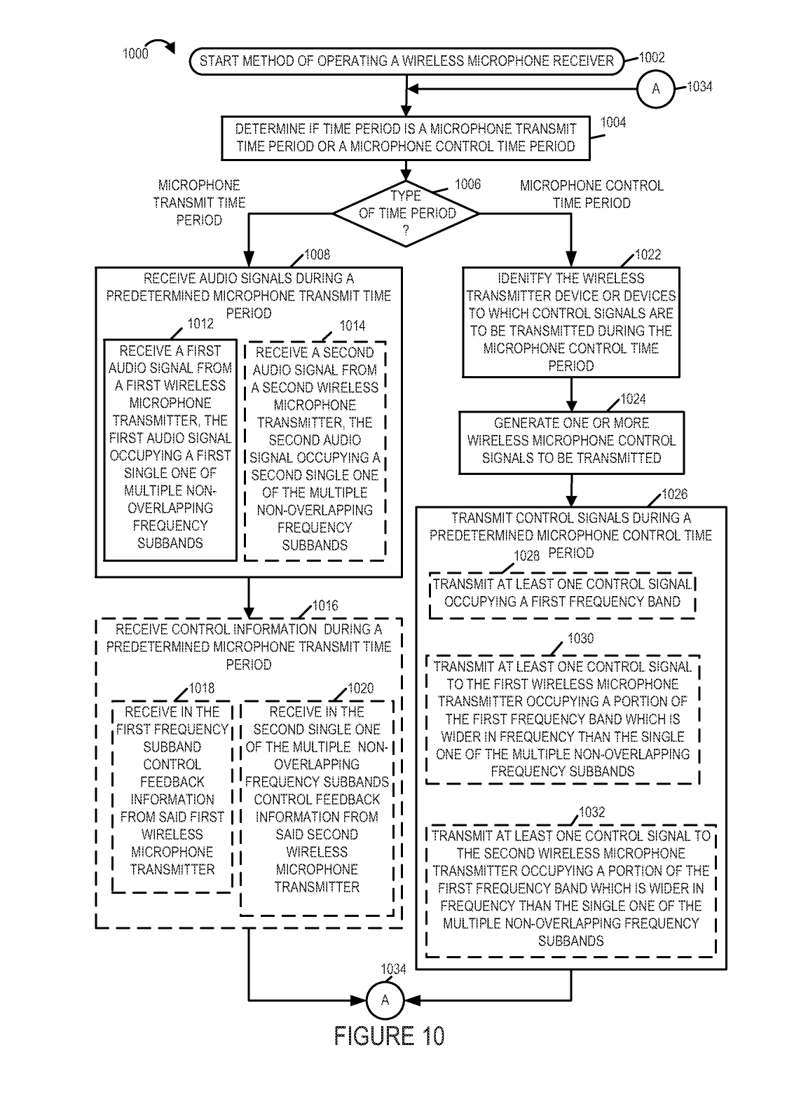

FIG. 10 is a flowchart 1000 of an exemplary method of operating a wireless microphone receiver in accordance with various embodiments. The exemplary method of flowchart 1000 uses a time division multiplexing (TDM) approach to support communications of audio traffic and control signaling. Operation of the exemplary method starts in step 1002, where the wireless microphone receiver is powered on and initialized. Operation proceeds from start step 1002 to step 1004. In step 1004 the wireless microphone receive determines if a time period is a microphone transmit time period or a microphone control time period. Operation proceeds from step 1004 to step 1006. In step 1006 the wireless microphone device controls operation as a function of the determination of the type of time period. If the upcoming time period is a microphone transmit time period, then operation proceeds from step 1006 to step 1008; however, if the upcoming time period is a microphone control time period then operation proceeds from step 1006 to step 1022.

Returning to step 1008, in step 1008 the wireless microphone device receives audio signals, e.g., audio traffic, during a predetermined microphone transmit time period, e.g. an uplink time slot dedicated for transmissions from the wireless microphone transmitters. Step 1008 includes step 1012 and may, and sometimes does also include step 1014. In step 1012 the wireless receiver device receives a first audio signal from a first wireless microphone transmitter, the first audio signal occupying a first single one of the multiple non-overlapping frequency subbands. In step 1014, the wireless microphone receiver receives a second audio signal from a second wireless microphone transmitter, the second audio signal occupying a second single one of the multiple non-overlapping frequency subbands. In some embodiments, operation proceeds from step 1008 to step 1016. In other embodiments, operation may, and sometimes does, proceed from step 1008 to step 1016. In still other embodiments, step 1016 is bypassed and operation proceeds from step 1008 to connecting node A 1034.

Returning to step 1016, in step 1016 the wireless microphone receiver receives control information during a predetermined microphone transmit time period. Step 1016 may, and sometimes does, include one or more of step 1018 and step 1020. In step 1018, the wireless microphone receiver receives in the first frequency subband control feedback information from said first wireless microphone transmitter. In step 1020 the wireless microphone transmitter receives in the second single one of the multiple non-overlapping frequency subbands control feedback information from said second wireless microphone transmitter. In some embodiments, the control feedback information transmitted from a wireless microphone transmitter is, e.g., battery status information indicating remaining battery power of the wireless microphone transmitter. Operation proceeds from step 1016 to connecting node A 1034.

Returning to step 1022, in step 1022 the wireless microphone identifies the wireless transmitter device or devices to which control signals are to be transmitted during the microphone control time period. In some embodiments, the identification of step 1022 is in accordance with a predetermined mapping structure in which individual microphone control time periods are dedicated to a set of one or more wireless transmitter devices currently corresponding to a particular frequency subband in the first frequency band. Operation proceeds from step 1022 to step 1024. In step 1024 the wireless microphone receiver generates one or more wireless microphone control signals to be transmitted. Operation proceeds from step 1024 to step 1026.

In step 1026 the wireless microphone receiver transmits control signals during a predetermined microphone control time period. Step 1026, in some embodiments, includes one or more or all of steps 1028, 1030 and 1032. In some embodiments, some of steps 1028, 1030 and 1032 may be performed jointly. In step 1028 the wireless microphone receiver transmits at least one control signal occupying a first frequency band. In some embodiments, the air link resource of a particular microphone control time period in the timing frequency structure is dedicated to communications with a single wireless transmitter device. In some embodiments, the wireless receiver device may, and sometimes does communicate with multiple wireless microphone transmitters during a particular microphone control time period in the recurring timing frequency structure; however, a transmitted control signal to a single wireless microphone transmitter occupies a portion of the first frequency band larger than a subband used for audio data signal communications. In step 1030 the microphone receiver device transmits at least one control signal to the first wireless microphone transmitter occupying a portion of the first frequency band which is wider in frequency than the single one of the multiple non-overlapping frequency subbands. In step 1032 the wireless microphone receiver transmits at least one control signal to the second wireless microphone transmitter occupying a portion of the first frequency band which is wider in frequency than the single one of the multiple non-overlapping frequency subbands.

In some embodiments, the control signals transmitted by the wireless microphone receiver include one or more or all of: power control signal, timing synchronization signals, closed loop symbol timing control signals, filter control signals, and channel assignment signals. In some embodiments, control signals transmitted by the wireless microphone receiver include a control signal used to mute an individual one of a plurality of wireless microphone transmitters.

Operation proceeds from step 1026 to connecting node A 1034. Operation proceeds from connecting node A 1034 to step 1004 for determination of the type of the next upcoming time period.

In various embodiments, the first frequency band includes multiple non-overlapping subbands and control signals transmitted by the wireless microphone receiver are transmitted in the first frequency band. In some embodiments, different frequency subbands are dedicated to different wireless microphone transmitters for communicating with the wireless microphone receiver. In some embodiments, the first frequency band is used at different time for communicating control information to different wireless microphone transmitters. In some such embodiments, the first frequency band is used for communicating control information to a single one of said different wireless microphone transmitters at a given time.

In one exemplary embodiment, the first wireless microphone receiver is wireless microphone receiver device 102 of system 100 of FIG. 1, which implements a method in accordance with flowchart 1000 of FIG. 10; the first wireless microphone transmitter is wireless microphone transmitter 1 device 104 of system 100; and the second wireless microphone transmitter is wireless microphone transmitter 2 device 106 of system 100 of FIG. 1. In one such embodiment, the first subband is frequency subband 1 912 of FIG. 9, the second subband is frequency subband 2 914 of FIG. 9, and the first band is first frequency band 910 of FIG. 9.

The method of flowchart 1000 of FIG. 10 is described with respect to two wireless transmitter devices communicating with the wireless receiver device. In various embodiments, the method of flowchart 1000 is extended to include communications with more than two wireless microphone transmitters, e.g., up to N wireless microphone transmitters where N is the number of frequency subbands in the first frequency band that may be assigned to wireless microphone transmitter devices. Thus step 1008 may, at times, include reception of audio signals from N different wireless microphone transmitters in N different non-overlapping subbands of the first frequency band, respectively. In addition, step 1016 may, at times, include reception of control information from N different wireless microphone transmitters in N different non-overlapping subbands of the first frequency band, respectively. In addition step 1026 may, at times include transmission of a control signal to any one of N different wireless microphone transmitters, e.g., in accordance with the scheduling structure.

In some embodiments, step 1008 and step 1016 are performed jointly, e.g., in parallel. In some embodiments, in which step 1016 is not included audio data signals are received by the wireless receiver device from wireless microphone transmitters during microphone transmit time intervals; however, control information is not received. In some such embodiments, wireless microphone transmitter devices transmit control information to the microphone receiver during some of the microphone control time periods. In some such embodiments, a particular microphone control time period in the recurring timing structure is designated as either a control information receive time period or a control information transmit time period with respect to the wireless microphone receiver. In some such embodiments, a particular wireless microphone control receive time period corresponds to a single wireless microphone transmitter.

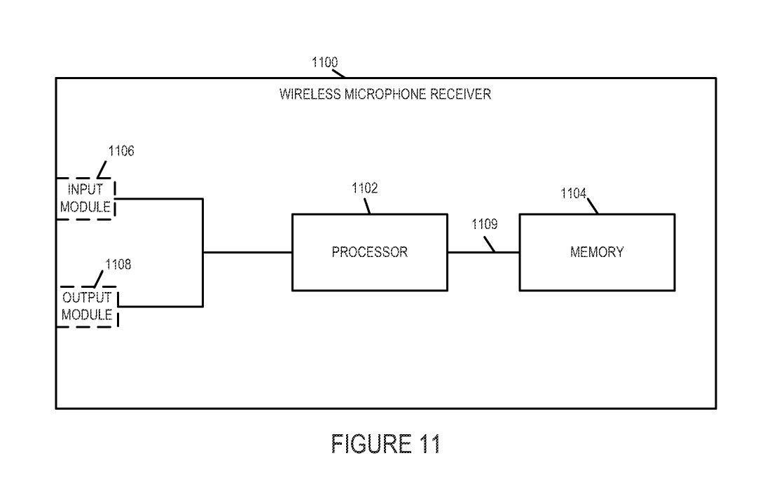

FIG. 11 is a drawing of an exemplary wireless microphone receiver 1100, in accordance with an exemplary embodiment. Exemplary wireless microphone receiver 1100 may be used as the wireless microphone receiver 102 of FIG. 1. Exemplary wireless microphone receiver 1100 may, and sometimes does, implement a method in accordance with flowchart 1000 of FIG. 10.

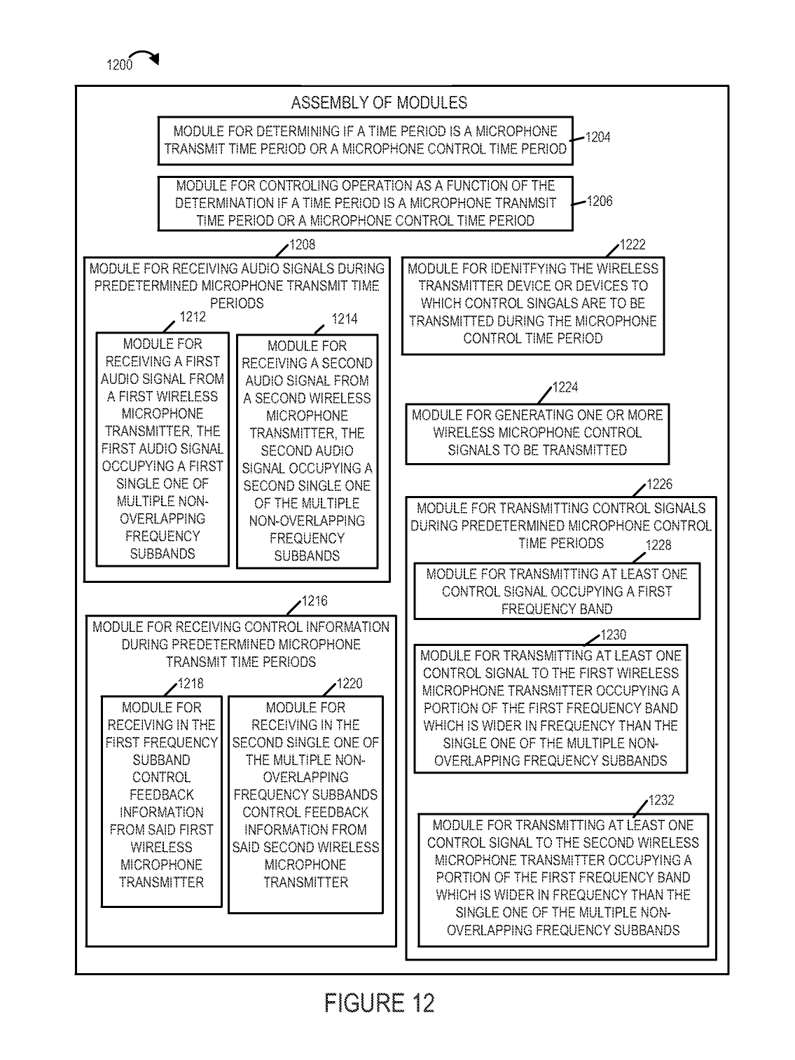

The wireless microphone receiver 1100 includes a processor 1102 and memory 1104 coupled together via a bus 1109 over which the various elements (1102, 1104) may interchange data and information. The memory 1104 may include an assembly of modules used to control the wireless microphone receiver 1100, e.g., such as the assembly of modules shown in FIG. 12. The wireless microphone receiver 1100 further includes an input module 1106 and an output module 1108 which may be coupled to processor 1102 as shown. However, in some embodiments, the input module 1106 and output module 1108 are located internal to the processor 1102. Input module 1106 can receive input signals. Input module 1106 can, and in some embodiments does, include a wireless receiver and/or a wired or optical input interface for receiving input. Output module 1108 may include, and in some embodiments does include, a wireless transmitter and/or a wired or optical output interface for transmitting output.

In various embodiments, processor 1102 is configured to receive audio signals during predetermined microphone transmit time periods and transmit control signals during predetermined microphone control time periods. In some embodiments, processor 1102 is configured to transmit at least one control signal occupying a first frequency band, as part of being configured to transmit control signals during predetermined microphone control time periods.

In various embodiments, a first frequency band includes multiple non-overlapping frequency subbands, and processor 1102 is configured to transmit said control signals in said first frequency band, as part of being configured to transmit control signals during predetermined microphone control time periods. In some such embodiments, processor 1102 is configured to receive a first audio signal from a first wireless microphone transmitter as part of being configured to receive audio signals during predetermined microphone transmit time periods and the first audio signal occupies a first single one of said multiple non-overlapping frequency subbands.

In some embodiments, processor 1102 is configured transmit at least one control signal to the first wireless microphone transmitter, as part of being configured to transmit control signals, and the at least one control signal occupies a portion of the first frequency band which is wider in frequency than said single one of said multiple non-overlapping frequency subbands.

In various embodiments, processor 1102 is configured to receive a second audio signal from a second wireless microphone transmitter, as part of being configured to receive audio signals, and the second audio signal occupies a second single one of said multiple non-overlapping frequency subbands.

In some embodiments, processor 1102 is further configured to receive, in said first frequency subband, control feedback information from said first wireless microphone transmitter.

In various embodiments, different frequency subbands are dedicated to different wireless microphone transmitters for communicating with said wireless microphone receiver, e.g., for transmitting audio data signals, and in some embodiments, control signals in addition to the audio data signals, to the wireless microphone receiver. In some embodiments, said first frequency band is used at different times for communicating control information to different wireless microphone transmitters. In some such embodiments, the first frequency band is used for communicating control information to a single one of said different wireless microphone transmitters at a given time. In some such embodiments, processor 1102 is configured to determine which single one of the different wireless microphone transmitters information is to be communicated to at a given time, e.g., for a given microphone control time period, e.g., in accordance with a predetermined structure.

FIG. 12 illustrates an assembly of modules 1200 which can, and in some embodiments is, used in a wireless microphone receiver such as the wireless microphone receiver 1100 illustrated in FIG. 11 and/or the wireless microphone receiver 102 illustrated in FIG. 1. The modules in the assembly of modules 1200 can be implemented in hardware within the processor 1102 of FIG. 11, e.g., as individual circuits. Alternatively, the modules may be implemented in software and stored in the memory 1104 of the wireless microphone receiver 1100 shown in FIG. 11. While shown in the FIG. 11 embodiment as a single processor, e.g., computer, it should be appreciated that the processor 1102 may be implemented as one or more processors, e.g., computers.

When implemented in software the modules include code, which when executed by the processor, configure the processor, e.g., computer, 1102 to implement the function corresponding to the module. In some embodiments, processor 1102 is configured to implement each of the modules of the assembly of modules 1200. In embodiments where the assembly of modules 1200 is stored in the memory 1104, the memory 1104 is a computer program product comprising a computer readable medium comprising code, e.g., individual code for each module, for causing at least one computer, e.g., processor 1102, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 12 control and/or configure the wireless microphone receiver 1100 or elements therein such as the processor 1102, to perform the functions of the corresponding steps illustrated and/or described in the method of flowchart 1000 of FIG. 10.

The assembly of modules 1200 includes a module corresponding to each step of the method of flowchart 1000 shown in FIG. 10. For example module 1204 corresponds to step 1004 and is responsible for performing the operation described with regard to step 1004. The assembly of modules 1200 includes a module for determining if a time period, e.g., an upcoming time period, is a microphone transmit time period or a microphone control time period 1204, a module for controlling operation as a function of the determination if a time period is a microphone transmit time period or a microphone control time period 1206.

Assembly of modules 1200 further includes a module for receiving audio signals during predetermined microphone transmit time periods 1208, and a module for receiving control information during predetermined microphone transmit time periods 1216. Module 1208 includes a module 1212 for receiving a first audio signal from a first wireless microphone transmitter, wherein the first audio signal occupies one of multiple non-overlapping subbands, and a module 1214 for receiving a second audio signal from a second wireless microphone transmitter, wherein the second audio signal occupies a second single one of the multiple non-overlapping frequency subbands. Module 1216 includes a module 1218 for receiving in the first frequency subband control feedback information from said first wireless microphone transmitter and a module 1220 for receiving in the second single one of the multiple non-overlapping frequency subbands control feedback information from said second wireless microphone transmitter.

Assembly of modules 1200 further includes a module for identifying the wireless transmitter device or devices to which control signals are to be transmitted during the microphone control time period 1222, a module for generating one or more wireless microphone control signals to be transmitted 1224 and a module for transmitting control signals during predetermined microphone control time periods 1226. Module 1226 includes a module for transmitting at least one control signal occupying a first frequency band 1228, a module for transmitting at least one control signal to the first wireless microphone transmitter occupying a portion of the first frequency band which is wider in frequency than the single one of the multiple non-overlapping frequency subbands 1230 and a module for transmitting at least one control signal to the second wireless microphone transmitter occupying a portion of the first frequency band which is wider in frequency than the second single one of the multiple non-overlapping frequency subbands 1232. In some embodiments, the portion is the full first frequency band.

In some embodiments, the first frequency band includes multiple non-overlapping frequency subbands, e.g., the first frequency band is partitioned into a set of non-overlapping frequency subbands. In various embodiments, different frequency subbands are dedicated to different wireless microphone transmitters for communicating with said wireless microphone receiver.

In some embodiments, said first frequency band is used at different times for communicating control information to different wireless microphone transmitters. In some such embodiments, said first frequency band is used for communicating control information to a single one of said different wireless microphone transmitters at a given time.

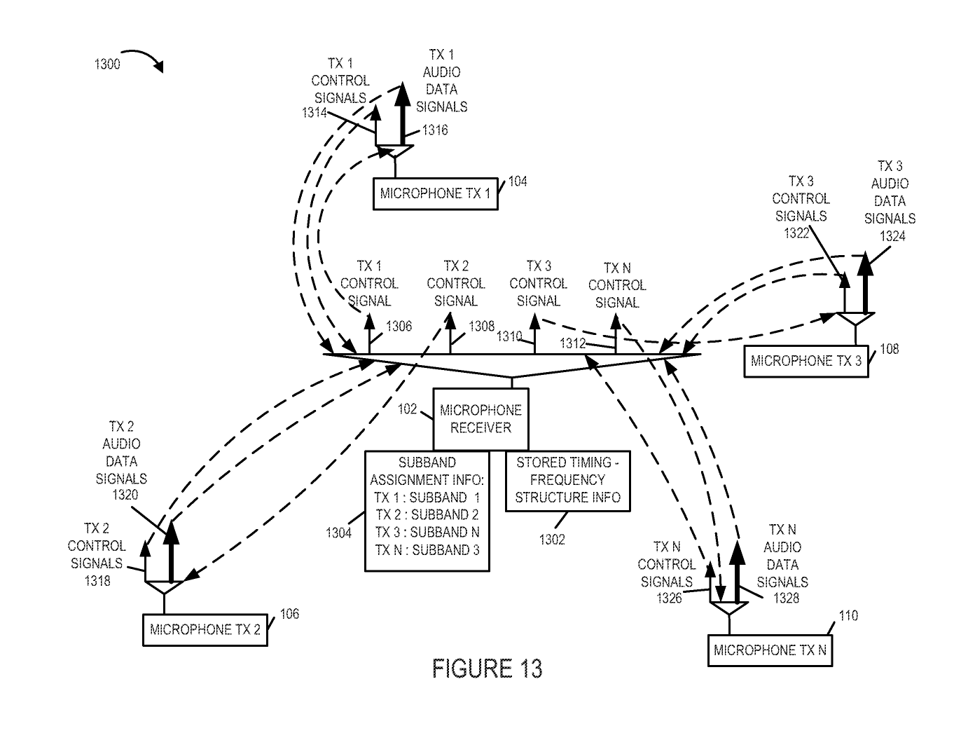

FIGS. 13-15 illustrate an example, in which an exemplary wireless microphone receiver implements a method in accordance with flowchart 1000 of FIG. 10. Drawing 1300 of FIG. 13 illustrates exemplary wireless microphone receiver 102 communicating with a plurality of wireless microphone transmitters (wireless microphone transmitter 1 104, wireless microphone transmitter 2 106, wireless microphone transmitter 3 108, and wireless microphone transmitter N 110). Wireless microphone receiver 102 includes stored timing frequency structure information 1302 in its memory. Wireless microphone receiver 102 has determined subband assignment information 1304 which identifies that: wireless microphone transmitter device 1 104 is currently assigned subband 1, wireless microphone transmitter device 2 106 is currently assigned subband 2, wireless microphone transmitter device 3 108 is currently assigned subband N, and wireless microphone transmitter device N 110 is currently assigned subband 3. The wireless microphone receiver device uses the audio channel assignment information 1304 and stored timing—frequency structure information 1302 to identify the air link resources corresponding to the control signaling and audio data signaling corresponding to the different wireless microphone transmitter devices.

Wireless microphone receiver 102 generates and transmits control signals (wireless microphone transmitter 1 control signal 1306, wireless microphone transmitter 2 control signal 1308, wireless microphone transmitter 3 control signal 1310, wireless microphone transmitter N control signal 1312) to wireless microphone transmitters (104, 106, 108, 110), respectively. Each of the wireless microphone transmitters (104, 106, 108, 110) generates and transmits control signals and audio data signals. Wireless microphone receiver 102 receives control signals 1314 and audio data signals 1316 from wireless microphone transmitter 1 104. Wireless microphone receiver 102 receives control signals 1318 and audio data signals 1320 from wireless microphone transmitter 2 106. Wireless microphone receiver 102 receives control signals 1322 and audio data signals 1324 from wireless microphone transmitter 3 108. Wireless microphone receiver 102 receives control signals 1326 and audio data signals 1328 from wireless microphone transmitter N 110. Although each of the signals (1314, 1316, 1318, 1320, 1322, 1324, 1326 and 1328) are shown as single arrows, each arrow may represent multiple different signals transmitted during different time periods in accordance with the timing frequency structure.

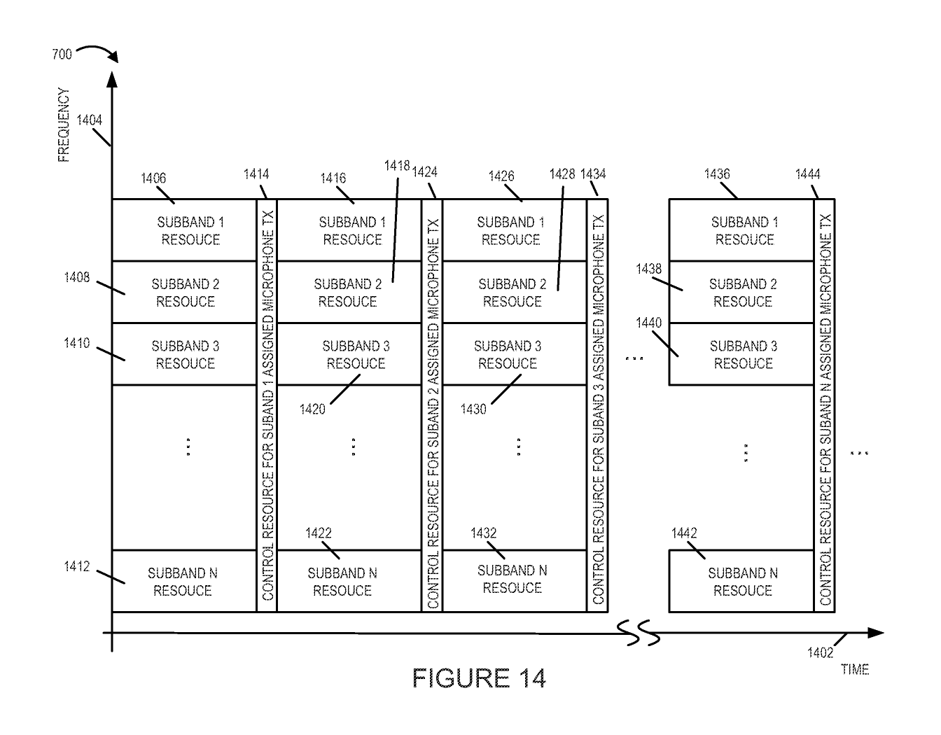

Drawing 1400 of FIG. 14 illustrates an exemplary timing frequency structure, which may represent the stored timing frequency structure information 1302 of FIG. 13. The timing frequency structure of FIG. 14 may correspond to the timing frequency structure of FIG. 9. Horizontal axis 1402 represents time and vertical axis 1404 represents frequency. A first frequency band is partitioned into N subbands. During a first microphone transmit time period there are airlink resources corresponding to each of the subbands (subband 1 resource 1406, subband 2 resource 1408, subband 3 resource 1410, . . . , subband N resource 1412) which are to be used for uplink signaling including audio data traffic signals and control signals from the assigned wireless microphone transmitters, respectively, to the wireless microphone receiver. During a first control signaling time period there is an air link resource 1414 occupying the full first frequency band which is to be used for downlink control signaling from the wireless microphone receiver to the microphone transmitter currently assigned to subband 1 for its audio data traffic. During a second microphone transmit time period there are airlink resources corresponding to each of the subbands (subband 1 resource 1416, subband 2 resource 1418, subband 3 resource 1420, . . . , subband N resource 1422) which are to be used for uplink signaling including audio data traffic signals and control signals from the assigned wireless microphone transmitters, respectively, to the wireless microphone receiver. During a second control signaling time period there is a air link resource 1424 occupying the full first frequency band which is to be used for downlink control signaling from the wireless microphone receiver to the microphone transmitter currently assigned to subband 2 for its audio data traffic. During a third microphone transmit time period there are airlink resources corresponding to each of the subbands (subband 1 resource 1426, subband 2 resource 1428, subband 3 resource 1430, . . . , subband N resource 1432) which are to be used for uplink signaling including audio data traffic signals and control signals from the assigned wireless microphone transmitters, respectively, to the wireless microphone receiver. During a third control signaling time period there is a air link resource 1434 occupying the full first frequency band which is to be used for downlink control signaling from the wireless microphone receiver to the microphone transmitter currently assigned to subband 3 for its audio data traffic. During an Nth. microphone transmit time period there are airlink resources corresponding to each of the subbands (subband 1 resource 1436, subband 2 resource 1438, subband 3 resource 1440, . . . , subband N resource 1442) which are to be used for uplink signaling including audio data traffic signals and control signals from the assigned wireless microphone transmitters, respectively, to the wireless microphone receiver. During an Nth control signaling time period there is a single air link resource 1444 occupying the full first frequency band which is to be used for downlink control signaling from the wireless microphone receiver to the microphone transmitter currently assigned to subband N for its audio data traffic.

In some embodiments, a control signaling time period air link resource, e.g., resource 1414 conveys a single OFDM symbol.

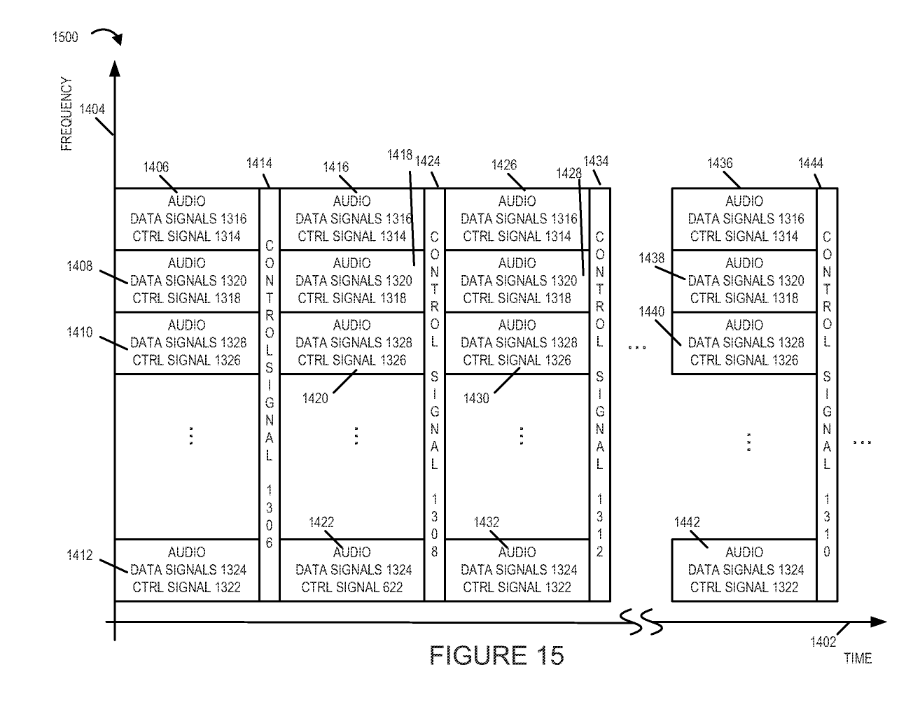

Drawing 1500 of FIG. 15 illustrates which air link resources of FIG. 15 are used to convey the various signals of FIG. 13 in accordance with the current subband assignment information 1304 of FIG. 13. Audio data signals 1316 and control signals 1314 transmitted from wireless microphone transmitter 1 104 and received by wireless microphone receiver 102 are communicated using air link resource 1406. Audio data signals 1320 and control signals 1318 transmitted from wireless microphone transmitter 2 106 and received by wireless microphone receiver 102 are communicated using air link resource 1408. Audio data signals 1328 and control signals 1326 transmitted from wireless microphone transmitter N 110 and received by wireless microphone receiver 102 are communicated using air link resource 1410. Audio data signals 1324 and control signals 1322 transmitted from wireless microphone transmitter 3 108 and received by wireless microphone receiver 102 are communicated using air link resource 1412. Control signal 1306 communicating information to control wireless microphone transmitter 1 is transmitted by wireless microphone receiver 102 using air link resource 1414 and is received by wireless transmitter 1 104.

Audio data signals 1316 and control signals 1314 transmitted from wireless microphone transmitter 1 104 and received by wireless microphone receiver 102 are communicated using air link resource 1416. Audio data signals 1320 and control signals 1318 transmitted from wireless microphone transmitter 2 106 and received by wireless microphone receiver 102 are communicated using air link resource 1418. Audio data signals 1328 and control signals 1326 transmitted from wireless microphone transmitter N 110 and received by wireless microphone receiver 102 are communicated using air link resource 1420. Audio data signals 1324 and control signals 1322 transmitted from wireless microphone transmitter 3 108 and received by wireless microphone receiver 102 are communicated using air link resource 1422. Control signal 1308 communicating information to control wireless microphone transmitter 2 is transmitted by wireless microphone receiver 102 using air link resource 1424 and is received by wireless transmitter 2 106.

Audio data signals 1316 and control signals 1314 transmitted from wireless microphone transmitter 1 104 and received by wireless microphone receiver 102 are communicated using air link resource 1426. Audio data signals 1320 and control signals 1318 transmitted from wireless microphone transmitter 2 106 and received by wireless microphone receiver 102 are communicated using air link resource 1428. Audio data signals 1328 and control signals 1326 transmitted from wireless microphone transmitter N 110 and received by wireless microphone receiver 102 are communicated using air link resource 1430. Audio data signals 1324 and control signals 1322 transmitted from wireless microphone transmitter 3 108 and received by wireless microphone receiver 102 are communicated using air link resource 1432. Control signal 1312 communicating information to control wireless microphone transmitter N is transmitted by wireless microphone receiver 102 using air link resource 1434 and is received by wireless transmitter N 110.

Audio data signals 1316 and control signals 1314 transmitted from wireless microphone transmitter 1 104 and received by wireless microphone receiver 102 are communicated using air link resource 1436. Audio data signals 1320 and control signals 1318 transmitted from wireless microphone transmitter 2 106 and received by wireless microphone receiver 102 are communicated using air link resource 1438. Audio data signals 1328 and control signals 1326 transmitted from wireless microphone transmitter N 110 and received by wireless microphone receiver 102 are communicated using air link resource 1440. Audio data signals 1324 and control signals 1322 transmitted from wireless microphone transmitter 3 108 and received by wireless microphone receiver 102 are communicated using air link resource 1442. Control signal 1310 communicating information to control wireless microphone transmitter 3 is transmitted by wireless microphone receiver 102 using air link resource 1444 and is received by wireless transmitter 3 108.

In the example of FIG. 13-15 a subband resource of a microphone transmit time period conveys both audio data signals and control signals in the uplink. In some embodiments, a subband resource of a microphone transmit time period conveys audio data signals but does not convey control signals. In some such embodiments, some of the control signaling time periods in the timing frequency structure are reserved, e.g., dedicated, for uplink control information signals. In the example, of FIG. 13-15, an air link resource of a control signaling time period is dedicated to convey control information to a single wireless microphone transmitter. In some other embodiments, an air link resource of a control signaling time period may be, and sometimes includes resource portions dedicated to convey control information to a plurality of different ones of multiple wireless microphone transmitters, wherein the portion of the first band dedicated for communication to a individual one of the multiple transmitters exceeds the width of a subband. For example, the control signaling time period resource may be partitioned to convey downlink wireless microphone transmitter control signals to two predetermined wireless microphone transmitters, with each portion receiving half of the first frequency band.

Various methods and apparatus described in this application are well suited for use in wireless microphone receivers, wireless microphone transmitters and networks supporting wireless microphone communications. In various embodiments a device of any of one or more of FIGS. 1-15 includes a module corresponding to each of the individual steps and/or operations described with regard to any of the Figures in the present application and/or described in the detailed description of the present application. The modules may, and sometimes are implemented in hardware. In other embodiments, the modules may, and sometimes are, implemented as software modules including processor executable instructions which when executed by the processor of the wireless communications device cause the device to implement the corresponding step or operation. In still other embodiments, some or all of the modules are implemented as a combination of hardware and software.

The techniques of various embodiments may be implemented using software, hardware and/or a combination of software and hardware. Various embodiments are directed to apparatus, e.g., wireless microphone receivers, control nodes, wireless microphone transmitters, microphone communications system. Various embodiments are also directed to methods, e.g., method of controlling and/or operating wireless microphone receivers, and wireless microphone transmitters, and microphone communications system. Various embodiments are also directed to a non-transitory machine, e.g., computer, readable medium, e.g., ROM, RAM, CDs, hard discs, etc., which include machine readable instructions for controlling a machine to implement one or more steps of a method.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal receiving, processing, and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium including machine executable instructions for causing a machine, e.g., processor and associated hardware, to perform one or more of the steps of the above-described method(s). Some embodiments are directed to a device, e.g., microphone device, including a processor configured to implement one, multiple or all of the steps of one or more above described methods.

In some embodiments, the processor or processors, e.g., CPUs, of one or more devices, e.g., microphone devices such as wireless microphone receivers and/or wireless microphone transmitters, are configured to perform the steps of the methods described as being performed by the microphone devices. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a microphone device, e.g., wireless microphone receiver and/or wireless microphone transmitter, with a processor which includes a module corresponding to each of the steps of the various described methods performed by the device in which the processor is included. In some but not all embodiments a microphone device, e.g., wireless microphone receiver and/or wireless microphone transmitter, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of operating a wireless microphone receiver and/or a wireless microphone transmitter. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a wireless microphone receiver, a wireless microphone transmitter or other device described in the present application.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), and/or various other types of communications techniques which may be used to provide wireless communications links between the microphone devices. In some embodiments, a wireless microphone receiver is implemented as a stationary device and communicates with microphone transmitters using OFDM and/or CDMA and may provide connectivity to a recording system, an amplification system, a processing, e.g., filtering system, and/or an output system, e.g., a speaker system. In various embodiments the microphone devices are implemented as portable devices including receiver/transmitter circuits and logic and/or routines, for implementing the methods.

What is claimed is:

1. A method of operating a wireless microphone receiver comprising:
transmitting wireless microphone transmitter control signals on a control channel corresponding to a first frequency band to control wireless microphone transmitter operation;
receiving at least one control signal from a first wireless microphone transmitter communicated on said control channel in said first frequency band; and
receiving audio signals from said first wireless microphone transmitter transmitted on an audio data channel in a second frequency band, said second frequency band being lower in frequency than said first frequency band.

2. The method of claim 1, wherein said control channel is a time division duplexed channel, said receiving at least one control signal is performed in predetermined time slots dedicated for receiving control signals from said first wireless microphone transmitter.

3. The method of claim 1, wherein said second frequency band is separated from said first frequency band by more than ¼ the carrier frequency of said first frequency band.

4. The method of claim 1, wherein said first frequency band is a 1900 MHz frequency band.

5. The method of claim 4, wherein said second frequency band is a 700 MHz frequency band.

6. A wireless microphone receiver comprising:
means for transmitting wireless microphone transmitter control signals on a control channel corresponding to a first frequency band to control wireless microphone transmitter operation;
means for receiving at least one control signal from a first wireless microphone transmitter communicated on said control channel in said first frequency band; and
means for receiving audio signals from said first wireless microphone transmitter transmitted on an audio data channel in a second frequency band, said second frequency band being lower in frequency than said first frequency band.

7. The wireless microphone receiver of claim 6, wherein said control channel is a time division duplexed channel, the wireless microphone device further comprising:
means for controlling said receiving of at least one control signal to be performed in predetermined time slots dedicated for receiving control signals from said first wireless microphone transmitter.

8. The wireless microphone receiver of claim 6, wherein said second frequency band is separated from said first frequency band by more than ¼ the carrier frequency of said first frequency band.

9. The wireless microphone receiver of claim 6, wherein said first frequency band is a 1900 MHz frequency band.

10. The wireless microphone receiver of claim 9, wherein said second frequency band is a 700 MHz frequency band.

11. A computer program product for use in a wireless microphone receiver, the computer program product comprising:
a non-transitory computer readable medium comprising:
code for causing at least one computer to transmit wireless microphone transmitter control signals on a control channel corresponding to a first frequency band to control wireless microphone transmitter operation;
code for causing said at least one computer to receive at least one control signal from a first wireless microphone transmitter communicated on said control channel in said first frequency band; and
code for causing said at least one computer to receive audio signals from said first wireless microphone transmitter transmitted on an audio data channel in a second frequency band, said second frequency band being lower in frequency than said first frequency band.

12. A wireless microphone receiver comprising:
at least one processor configured to:
transmit wireless microphone transmitter control signals on a control channel corresponding to a first frequency band to control wireless microphone transmitter operation;
receive at least one control signal from a first wireless microphone transmitter communicated on said control channel in said first frequency band; and
receive audio signals from said first wireless microphone transmitter transmitted on an audio data channel in a second frequency band, said second frequency band being lower in frequency than said first frequency band; and
memory coupled to said at least one processor.

13. The wireless microphone receiver of claim 12, wherein said control channel is a time division duplexed channel, and
wherein said at least one processor is further configured to control the receive of said at least one control signal to be performed in predetermined time slots dedicated for receiving control signals from said first wireless microphone transmitter.

14. The wireless microphone receiver of claim 12, wherein said second frequency band is separated from said first frequency band by more than ¼ the carrier frequency of said first frequency band.

15. The wireless microphone receiver of claim 12, wherein said first frequency band is a 1900 MHz frequency band.

16. A method of operating a wireless microphone receiver comprising:
receiving audio signals during predetermined microphone transmit time periods; and
transmitting control signals during predetermined microphone control time periods.

17. The method of claim 16, wherein said transmitting control signals includes transmitting at least one control signal occupying a first frequency band.

18. The method of claim 16, wherein a first frequency band includes multiple non-overlapping frequency subbands, said control signals being transmitted in said first frequency band; and
wherein receiving audio signals includes receiving a first audio signal from a first wireless microphone transmitter, said first audio signal occupying a first single one of said multiple non-overlapping frequency subbands.

19. The method of claim 18, wherein transmitting control signals includes transmitting at least one control signal to the first wireless microphone transmitter, said at least one control signal occupying a portion of the first frequency band which is wider in frequency than said single one of said multiple non-overlapping frequency subbands.

20. The method of claim 18,
wherein receiving audio signals includes receiving a second audio signal from a second wireless microphone transmitter, said second audio signal occupying a second single one of said multiple non-overlapping frequency subbands.

21. A wireless microphone receiver comprising:
means for receiving audio signals during predetermined microphone transmit time periods; and
means for transmitting control signals during predetermined microphone control time periods.

22. The wireless microphone receiver of claim 21, wherein said means for transmitting control signals includes means for transmitting at least one control signal occupying a first frequency band.

23. The wireless microphone receiver of claim 21, wherein a first frequency band includes multiple non-overlapping frequency subbands,
wherein said means for transmitting control signals transmits control signals in said first frequency band; and
wherein said means for receiving audio signals includes means for receiving a first audio signal from a first wireless microphone transmitter, said first audio signal occupying a first single one of said multiple non-overlapping frequency subbands.

24. The wireless microphone receiver of claim 23, wherein said means for transmitting control signals includes means for transmitting at least one control signal to the first wireless microphone transmitter, said at least one control signal occupying a portion of the first frequency band which is wider in frequency than said single one of said multiple non-overlapping frequency subbands.

25. The wireless microphone receiver of claim 23,
wherein said means for receiving audio signals includes means for receiving a second audio signal from a second wireless microphone transmitter, said second audio signal occupying a second single one of said multiple non-overlapping frequency subbands.

26. A computer program product for use in a wireless microphone receiver, the computer program product comprising:
a non-transitory computer readable medium comprising:
code for causing at least one computer to receive audio signals during predetermined microphone transmit time periods; and
code for causing said at least one computer to transmit control signals during predetermined microphone control time periods.

27. A wireless microphone receiver comprising:
at least one processor configured to:
receive audio signals during predetermined microphone transmit time periods; and
transmit control signals during predetermined microphone control time periods; and
memory coupled to said at least one processor.

28. The wireless microphone receiver of claim 27, wherein said at least one processor is configured to transmit at least one control signal occupying a first frequency band, as part of being configured to transmit control signals during predetermined microphone control time periods.

29. The wireless microphone receiver of claim 27, wherein a first frequency band includes multiple non-overlapping frequency subbands;
wherein said at least one processor is configured to transmit said control signals in said first frequency band, as part of being configured to transmit control signals during predetermined microphone control time periods;
wherein said at least one processor is configured to receive a first audio signal from a first wireless microphone transmitter as part of being configured to receive audio signals during predetermined microphone transmit time periods; and
wherein said first audio signal occupies a first single one of said multiple non-overlapping frequency subbands.

30. The wireless microphone receiver of claim 29, wherein said at least one processor is configured transmit at least one control signal to the first wireless microphone transmitter, as part of being configured to transmit control signals, and wherein said at least one control signal occupies a portion of the first frequency band which is wider in frequency than said single one of said multiple non-overlapping frequency subbands.
